(19) United States
(12) Patent Application Publication
(10) Pub. No.: US 2009/0161998 A1
(43) Pub. Date: Jun. 25, 2009

(54) Method for optimizing a grooved bearing pattern on a bearing surface of a fluid dynamic bearing for the purpose of improving the bearing properties and an appropriate grooved bearing pattern

(76) Inventors: Lei Jiang, Villingen-Schwenningen (DE); Martin Bauer, Villingen-Schwenningen (DE)

Correspondence Address: COOPER & DUNHAM, LLP, 30 Rockefeller Plaza, 20th Floor, NEW YORK, NY, 10112, US

(21) Appl. No.: 12/316,709

(22) Filed: Dec. 16, 2008

(30) Foreign Application Priority Data
Dec. 20, 2007 (DE) 10 2007 061 454.5

(51) Int. Cl. F16C 32/06

(52) U.S. Cl. 384/100

(57) ABSTRACT

The invention relates to a method for optimizing a grooved bearing pattern on a bearing surface of a fluid dynamic bearing for the purpose of improving the bearing properties as well as an appropriately designed grooved bearing pattern, the grooved bearing pattern having a defined length, width and depth, and the bearing surface being moveable with respect to another associated bearing surface in at least one direction of movement, having the following steps:

selection of a bearing property to be improved, optimization of the geometry of the grooved bearing pattern in respect of the bearing property to be improved by adjusting one or more of the following parameters of the grooved bearing pattern:
depth, width, length, angle with respect to direction of movement of the bearing surface or its normal, contour, geometry of the transition to adjacent surfaces.

### TECHNICAL FIELD OF THE INVENTION

The invention relates to a method for optimizing a grooved bearing pattern on a bearing surface of a fluid dynamic bearing for the purpose of improving the bearing properties of this bearing. An appropriate grooved bearing pattern for realizing the method is also described.

### PRIOR ART

Grooved bearing patterns of the type described above find application, for example, in fluid dynamic bearings, as used, for example, for the rotatable support of spindle motors. A fluid dynamic bearing comprises at least two preferably rotatable bearing parts moveable with respect to each other that are separated from one another by a bearing gap filled with bearing fluid. The bearing is given its load-carrying capacity by a fluid dynamic effect that, on operation of the bearing, causes a build up of pressure in the bearing fluid and thus in the bearing gap. This fluid dynamic effect is generated by bearing patterns that are provided on one or both of the bearing surfaces that face each other. On operation of the bearing, these bearing patterns generate a pumping effect on the bearing fluid and thus a build up of pressure in the bearing gap.

In order to build up the required hydrodynamic pressure and to make sufficient pressure available over the entire specified region, very high requirements are placed on the bearing patterns. Should negative pressure zones arise or the overall bearing pressure be too low, damage to the bearing or its failure could result. The design of the grooved bearing patterns determines the desired distribution of pressure in the bearing gap, sine-shaped grooved bearing patterns, for example, generating a different distribution of pressure than herringbone patterned grooved bearing patterns or spiral-shaped patterns. The characteristics of the pressure distribution in the bearing gap generated by the grooved bearing patterns depend, for example, on the depth of the grooved bearing patterns and on other dimensions such as length and width as well as the conformity of these geometric properties.

At high rotational speeds of the fluid dynamic bearing, cavitation effects play an increasingly important part. Due to cavitation effects, negative pressure zones are built up in the bearing in which air bubbles can escape from the bearing fluid and form air cushions that impair the function of the bearing and, in the worst case, result in a failure of the bearing. As a rule, the greatest negative pressure occurs at the ends of the grooved bearing patterns pointing away from the direction of flow. The present geometry of the ends of the grooved bearing patterns, which substantially always have the same width and depth, is not suited for the prevention of such negative pressure zones, particularly at high rotational speeds of the bearing.

### SUMMARY OF THE INVENTION

Based on the above-mentioned problems, it is the object of the invention to provide a method for optimizing a grooved bearing pattern on a bearing surface of a fluid dynamic bearing for the purpose of improving the bearing properties and also to provide an appropriate grooved pattern, where, in particular, the occurrence of negative pressure zones should be prevented.

This object has been achieved according to the invention by a method having the characteristics outlined in claim 1 as well as a grooved bearing pattern having the characteristics outlined in claim 12.

Preferred embodiments and advantageous characteristics of the invention are revealed in the subordinate claims.

According to the invention, a method for optimizing a grooved bearing pattern on a bearing surface of a fluid dynamic bearing for the purpose of improving the bearing properties is proposed, wherein the grooved bearing pattern has a defined length, width and depth, and the bearing surface is moveable with respect to another associated bearing surface in at least one direction of movement, wherein the method demonstrates the steps leading to the selection of a bearing property to be improved as well as the optimization of the geometry of the grooved bearing pattern in respect of the bearing property to be improved through the adjustment of one or more of the following parameters that determine the grooved bearing pattern:

depth, width, length, angle with respect to the direction of movement of the bearing surface or its normal, contour and geometry of the transition to adjacent surfaces.

The grooved bearing pattern according to the invention accordingly has geometric parameters that are adjusted with a view to improving the bearing property. These parameters relate to the depth, width, length, the angle with respect to the direction of movement of the bearing surface or its normal, the contour or the geometry of the transition to adjacent surfaces, such as the bearing surface itself or a surface on the same component that adjoins the bearing surface but does not belong to the bearing.

Therefore, according to the invention, the depth, the width and/or the length of the grooved bearing pattern, mainly the ends of the grooves, are adjusted in such a way that the bearing gap in the region of the grooved bearing pattern does not change abruptly in its width, in particular become larger, thus particularly avoiding the formation of negative pressure regions in the bearing gap. The depth and the width of the grooved bearing pattern preferably vary and particularly change over the length of the grooved bearing pattern, continuously or incrementally. This makes it possible to optimize various bearing properties in addition to the distribution of pressure in the bearing gap, particularly bearing stiffness, bearing damping, bearing play and bearing friction.

In order to minimize the occurrence of negative pressure zones, the groove depth should decrease or increase towards the rim. If the grooved bearing patterns adjoin a separator or a chamfer (channel), differences in pressure are easily compensated by the flow prevailing there.

In another embodiment of the invention, the width of the grooved bearing pattern is designed such that in the direction of the end pointing away from the direction of flow, it becomes continuously or incrementally larger. Excessive differences in pressure are also compensated in this way.

In yet another embodiment of the invention, the angle of the grooved bearing pattern is designed such that in the direction of the end pointing away from the direction of movement, it becomes continuously or incrementally smaller, the angle being measured with respect to the direction of movement.

In yet another embodiment of the invention, the width of the grooved bearing pattern is designed to be continuously or incrementally larger both in the direction of the end pointing away from the direction of movement as well as the end pointing in the direction of movement than in the remaining sections of the grooved bearing pattern.

In general, the grooved bearing pattern can be used for an axial bearing, a radial bearing or a tapered bearing, the bearing surfaces then comprising a plurality of bearing patterns that are disposed in the same geometric alignment at a distance from one another, wherein the distance may vary over the length of the bearing patterns.

In particular, several grooved bearing patterns may also be separated from one another by one or more channels disposed on the bearing surface or by raised zones higher than the bearing grooves, called land zones, the grooved bearing patterns preferably beginning in a common channel or land zone and/or ending in a common channel or land zone.

Various embodiments of the invention are described in more detail below on the basis of the drawings. Further advantages and characteristics of the invention can be derived from the drawings and their description.

### BRIEF DESCRIPTION OF THE DRAWINGS

FIG. 1a to 1f shows a view of various grooved bearing patterns in a view from above as well as a depth profile associated with each grooved bearing pattern, FIG. 1a representing the prior art.

FIG. 2 shows a three dimensional view of a bearing pattern having a varying width and depth as well as a varying angle with respect to the direction of flow of the bearing fluid.

FIG. 3a shows a first embodiment of grooved bearing patterns, one variation having straight edges (broken lines) and the other curved edges (unbroken lines).

FIG. 3b shows the grooved bearing patterns according to FIG. 3a, separated at the axis of symmetry by a continuous land zone.

FIG. 4a shows a second embodiment of the grooved bearing patterns being disposed at an offset with respect to one another and partly overlapping in the region of the central line, one variation having straight edges (broken lines) and the other curved edges (unbroken lines).

FIG. 4b shows a second embodiment of the grooved bearing patterns according to FIG. 4a in which, however, the ends of the grooved bearing patterns pointing in the direction of flow overlap the central axis, one variation having straight edges (broken lines) and the other curved edges (unbroken lines).

FIG. 4c shows a second embodiment of the grooved bearing patterns according to FIG. 4a, separated at the axis of symmetry by a continuous land zone.

FIG. 5a shows a third embodiment of the grooved bearing patterns according to the invention having substantially curved edges. Possible modifications of the ends or of the parts of the grooved bearing patterns extending in the direction of flow of the bearing fluid are additionally shown.

FIG. 5b shows the grooved bearing patterns according to FIG. 5a that are separated from one another at their axis of symmetry by a continuous land zone.

FIG. 6a shows a fourth embodiment of the grooved bearing patterns according to the invention having curved edges that are disposed at an offset to one another at their axis of symmetry or axis of movement respectively. The respective starting and end regions may be modified, as is shown by the broken lines.

FIG. 6b shows the bearing patterns according to FIG. 6a, these being disposed at an offset with respect to one another and partly overlapping in the region of the central axis.

FIG. 6c shows the bearing patterns according to FIG. 6a that are separated from one another at their axis of symmetry by a continuous land zone.

FIG. 7a shows a further embodiment of the bearing patterns according to the invention having substantially straight edges and alternatively having rounded corners (illustrated by broken lines).

FIG. 7b shows the bearing patterns according to FIG. 7a that are separated from one another at their axis of symmetry by a continuous land zone and the separated branches being disposed at an offset with respect to one another.

FIG. 7c shows bearing patterns according to FIG. 7a that are disposed at an offset with respect to one another along their central axis and partly overlap in the region of the axis of symmetry.

FIG. 7d shows a grooved bearing pattern according to FIG. 7a that has a dual peak in the direction of flow.

FIG. 8 shows a view from above of an axial bearing surface having spiral-shaped bearing patterns that have a common land zone at the inside diameter.

FIG. 9 shows a view from above of an axial bearing surface having herringbone patterns that break through at the inside diameter and have very acute angles at the outer ends.

FIG. 10 shows a view from above of an axial bearing surface having grooved bearing patterns, a land zone being provided approximately at a central diameter of the annular bearing surface, grooved bearing patterns that are disposed substantially symmetric with respect to each other adjoining the land zone.

FIG. 11 shows an arrangement according to FIG. 10, wherein, however, starting from the land zone, the grooved bearing patterns are disposed at an offset with respect to one another.

### DESCRIPTION OF PREFERRED EMBODIMENTS OF THE INVENTION

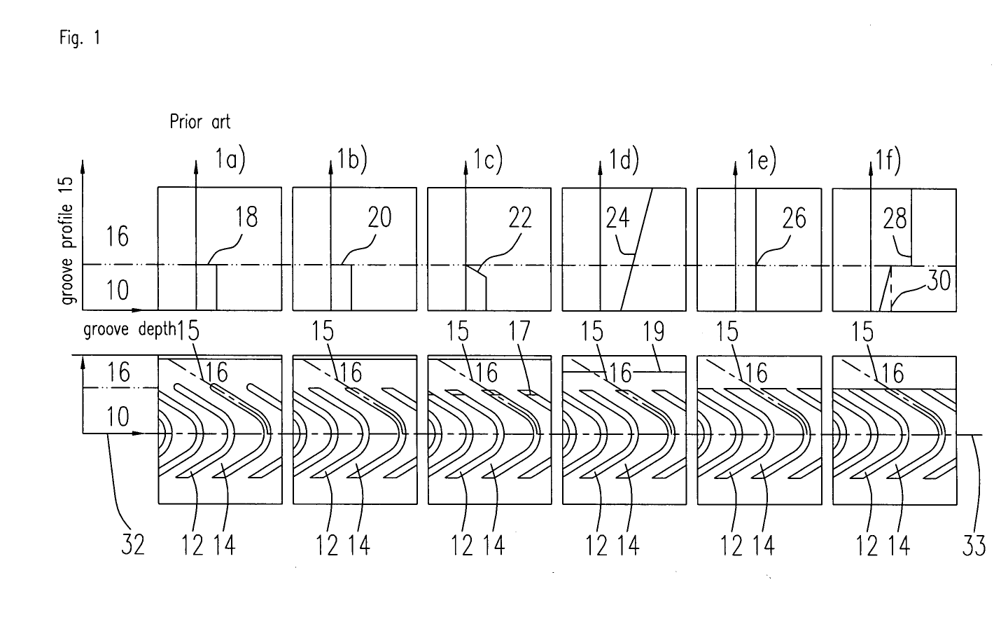

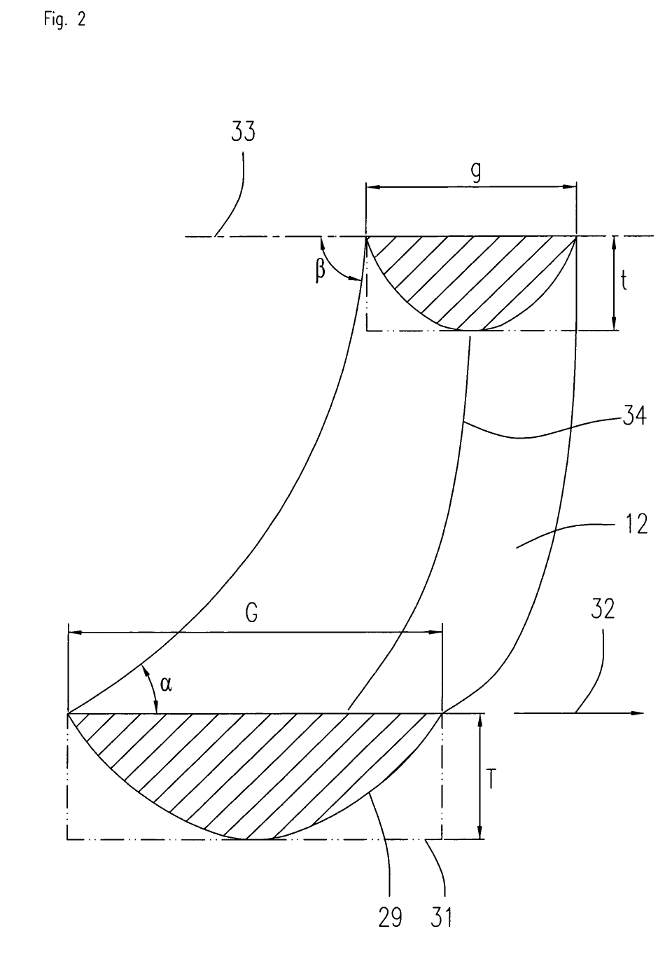

The present invention also proposes, in particular, to change, variably or incrementally, the depth, width and the angle of the grooved bearing patterns over their length in order to control the pumping effect on the bearing fluid generated by the grooved bearing patterns and the pressure generated in the bearing gap. FIG. 1 shows several variants 1a to 1f of grooved bearing patterns for a radial bearing that, in the example, are formed as sine-shaped grooved bearing patterns that are disposed within a bearing zone 10. The bearing zone 10, which comprises the grooved bearing patterns 12, is bounded by a rim zone 16. In the lower section of the respective drawings 1a to 1f, a view from above of the bearing surface having grooved bearing patterns is shown, whereas in the upper section, a depth profile of the grooved bearing patterns along the measuring line 15 is shown.

FIG. 1a depicts the prior art. FIG. 1a shows grooved bearing patterns 12 that are formed in a bearing surface 14, the depth of the grooved bearing patterns within the bearing zone 10 being constant and, at the end of the grooved bearing patterns, where the bearing zone merges into the rim zone 16, returning to zero. This means that the rim zone 16 lies on the same plane as the bearing surface 14, the grooved bearing patterns 12 lying below this plane.

FIG. 1b shows grooved bearing patterns 12 that are formed on a bearing surface 14 which substantially have the same shape and depth structure as the bearing patterns in FIG. 1a. In contrast to FIG. 1a, FIG. 1b shows grooved bearing patterns 12 that, in the transition between the bearing zone 10 and the rim zone 16, are squared off in shape and define a sharp edge. It has been proven that by making the edges angular in shape, a slight improvement in the negative pressure behavior in this region can be achieved, this means that the difference in pressure at the end of the bearing patterns in the transition between the bearing zone 10 and the rim zone 16 is not as sharp as in the embodiment according to FIG. 1a.

FIG. 1c shows grooved bearing patterns 12 embedded in a bearing surface 14 of a bearing zone 10 that are made deeper compared to the bearing surface and rim zone 16. The depth of the bearing groove 12 in the region 17 of the transition to the rim zone 16 does not increase abruptly but rather steadily, as can be seen from the depth profile 22. Through this gentle transition between the grooved bearing pattern 12 and the rim 16, negative pressure zones in the region of the transition are avoided.

FIG. 1d shows grooved bearing patterns 12 whose depth increases from the central axis 33 in the direction of the rim, and the depth profile 24 continues in the rim zone itself. Thus compared to the grooved bearing patterns 12, the rim zone 16 has a depth of the same size or deeper that changes in an axial direction in accordance with depth profile 24. This measure produces a uniform expansion of pressure over the length of the bearing pattern 12, so that negative pressure zones are avoided in the transition region between the bearing zone 10 and the rim zone 16.

FIG. 1e shows a depth profile 26, in which the rim zone 16 has the same depth as the grooved bearing patterns 12. The bearing surface 14 thus lies on a higher level than the rim zone 16. This depth remains uniform for the grooved bearing patterns as well as the rim zone 16. Here again, there is a gentle transition between the grooved bearing patterns and the rim zone, so that no negative pressure zones are created in the respective transition region.

In FIG. 1f, a depth profile is indicated by 28 in which the depth of the grooved bearing patterns 12 increases slightly from the central axis 33 to the rim. In the transition from the bearing zone 10 to the rim zone 16, the depth then once again increases abruptly, for example, to double the size of the depth of the grooved bearing pattern 12. This also goes to prevent negative pressure zones in the transition between the bearing zone and the rim zone 16. A modified embodiment is shown by depth profile 30 in which, in contrast to depth profile 28, the depth of the grooved bearing pattern 12 remains constant over its entire length.

FIG. 2 shows by way of example a view of a grooved bearing pattern 12 according to the invention where only half the length of the grooved bearing pattern is illustrated, starting from a central axis 33. For ideal pressure conditions, the grooves should have a rectangular cross-section 31, which, however, cannot be achieved using current production methods for grooved patterns, such as ECM, so that, in practice, a rounded profile, as shown, for example, by 29 is the result.

According to the invention, the grooved bearing pattern 12 has a variable depth over its course from the central line 33 to the rim, illustrated by the parameters t and T, as well as a variable width, illustrated by the parameters g and G. The depth and width change over the length of the grooved bearing pattern 12. Moreover, the angles α or β, which are formed between the edges of the grooved bearing pattern 12 and the direction of flow 32, also change. The grooved bearing pattern 12 has, for example, in its section pointing in the direction of flow 32, at the top of the drawing, a smaller depth t than at its end pointing away from the direction of flow 32, where it has depth T. Likewise, the width g in the section pointing in the direction of flow is smaller than the width G at the end pointing away from the direction of flow. It is also important that at the end pointing away from the direction of flow 32, the grooved pattern 12 forms a more acute angle α than at its section pointing in the direction of flow 32, angle β being considerably larger than α. According to the invention, all three parameters, depth, width and angle may be changed simultaneously or only one or two parameters may be changed simultaneously.

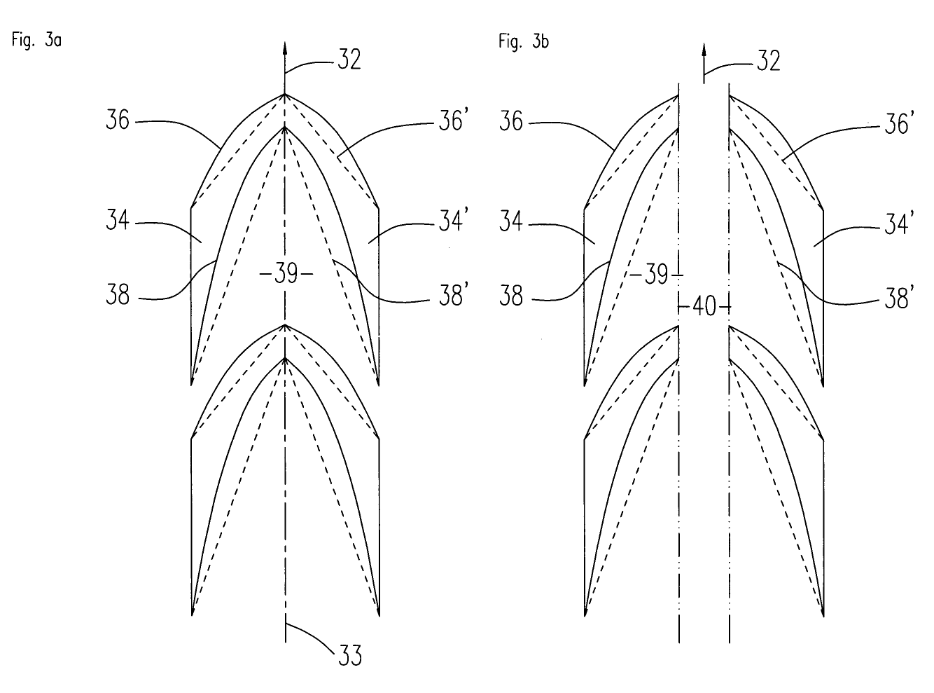

FIGS. 3a and 3b show possible embodiments of grooved bearing patterns 34 or 34′ respectively. The grooved bearing pattern 34 is formed with a curved front edge as well as a curved back edge 38, whereas the grooved bearing pattern 34′ illustrated by a broken line is formed with a straight front edge 36′ and a straight back edge 38′. The two patterns, both grooved bearing pattern 34 as well as pattern 34′, vary their width starting from the central axis 33 and their section pointing in the direction of flow 32 to the end pointing away from the direction of movement. In the case of the grooved pattern 34′ having straight edges, the angles with respect to the central axis 33 remain the same, whereas the grooved bearing pattern 34 having curved edges has a larger angle with respect to the central axis 33 at the end pointing in the direction of flow 32 than at the ends pointing away from the direction of movement. FIG. 3b shows grooved bearing patterns according to FIG. 3a that are separated, however, at their central axis by a land zone 40. The zone 40 preferably lies on the same plane as the bearing surface 38 surrounding the grooved bearing patterns.

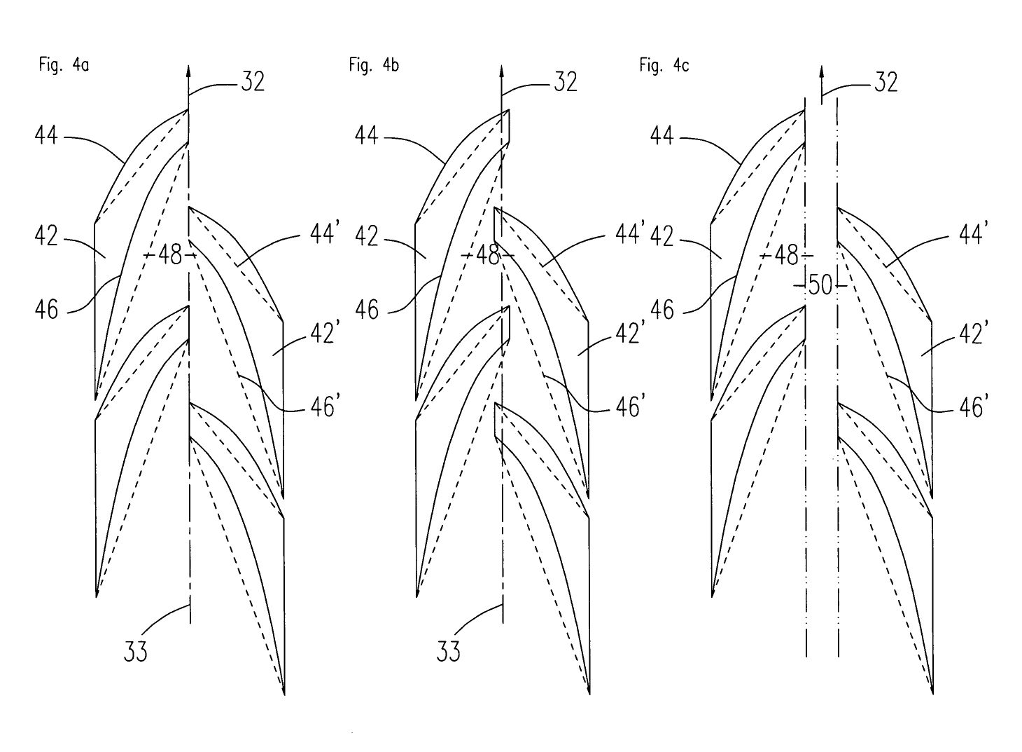

FIGS. 4a to 4c show further embodiments of the grooved bearing patterns according to the invention, one being a grooved bearing pattern 42 having a curved front edge 44 and back edge 46 and the other a grooved bearing pattern 42′ having a straight front edge 44′ and back edge 46′. The grooved bearing patterns 42 and 42′ are similar to the patterns of FIGS. 3a and 3b, but are each disposed at an offset with respect to one another along the central axis 33 in the direction of flow 32 and particularly have a variable width, the grooved bearing pattern 42 having curved edges also forming a variable angle with respect to the central axis 33.

FIG. 4b shows an embodiment in which the ends of the grooved bearing patterns 42 or 42′ pointing in the direction of flow 32 do not precisely abut the central axis 33, but rather overlap the central axis 33 and, as in the embodiment according to FIG. 4a, are disposed at an offset with respect to one another in the direction of flow 32.

FIG. 4c shows an embodiment substantially like that in FIG. 4a, where, however, the sections of the grooved bearing patterns 42 or 42′ are separated from one another by a land zone 50. The region of the land zone 50 may lie on the same plane as the bearing surface 48.

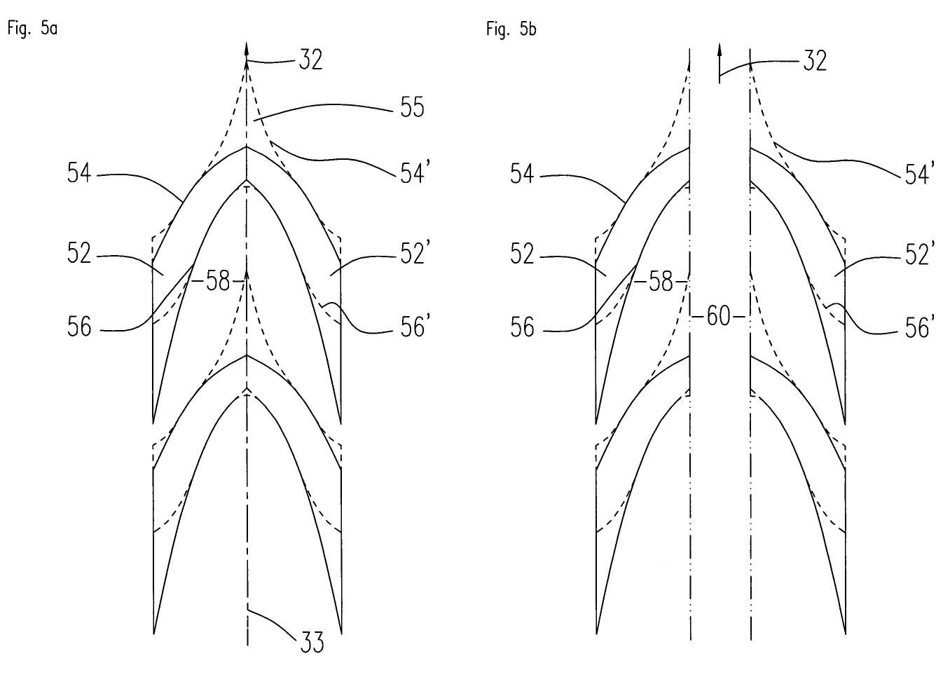

FIGS. 5a and 5b show a further embodiment of the grooved bearing patterns 52 or 52′ according to the invention, the grooved bearing patterns 52 being similar to the patterns according to FIG. 3a and having curved front edges 54 or back edges 56 respectively. The grooved bearing patterns 52 shown by the unbroken lines have rounded corners in the region of the section of the grooved bearing patterns pointing in the direction of flow 32. Through the rounded edges particularly in the direction of flow 32, pressure peaks are reduced since the pumping effect on the bearing fluid begins more gently than is the case with sharp edges. In variation 52′, the peak 55 ensures that the increased pressure that prevails in this region of the groove is distributed over a larger region and can thus have a more uniform effect.

In FIG. 5b, the embodiment according to FIG. 5a is shown, the sections of the grooved bearing patterns 52 and 52′ being separated from one another by a land zone 60.

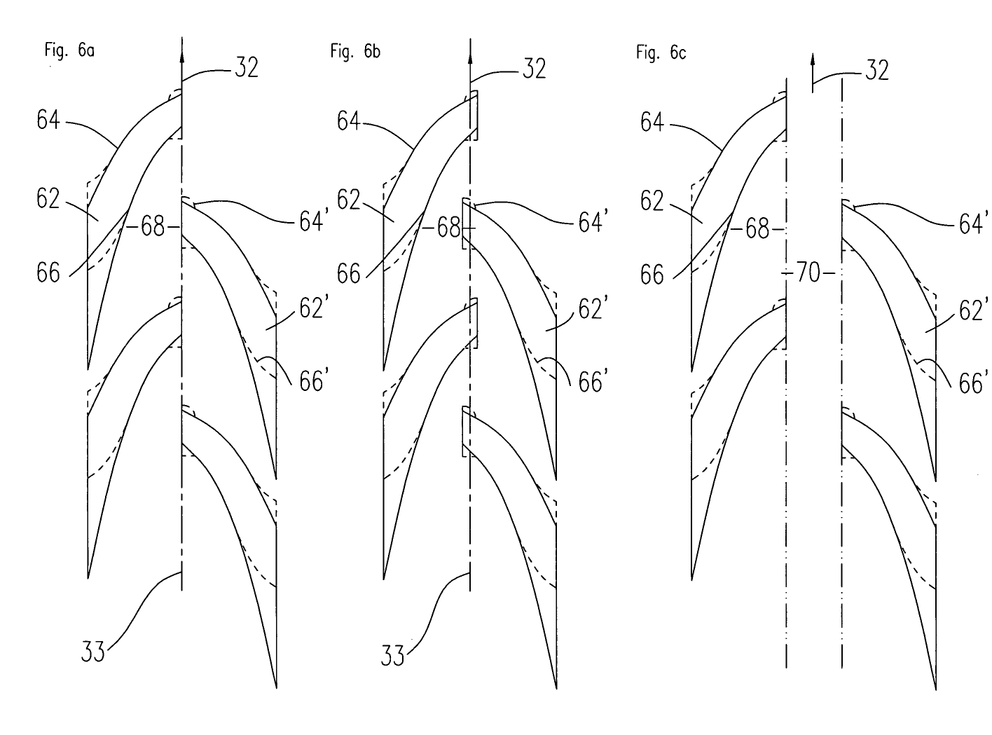

FIGS. 6a to 6c show grooved bearing patterns 62 or 62′ respectively that are very similar to the grooved bearing patterns of FIGS. 5a and 5b. In contrast to the grooved bearing patterns of FIGS. 5a and 5b, the grooved bearing patterns of FIGS. 6a to 6c are disposed at an offset with respect to one another along the central axis 33 and have curved front and back edges 64 or 66 or alternatively shaped front and back edges 64′ and 66′.

In FIG. 6b, the individual sections of the grooved bearing patterns 62 and 62′ are disposed with an overlap with respect to the central axis 33 and at an offset with respect to one another.

FIG. 6c shows an arrangement of the grooved bearing patterns 62 and 62′ that are separated from one another by a land zone 70. The section of the land zone 70 can be formed as a raised area that lies on the same plane as the bearing surface 68.

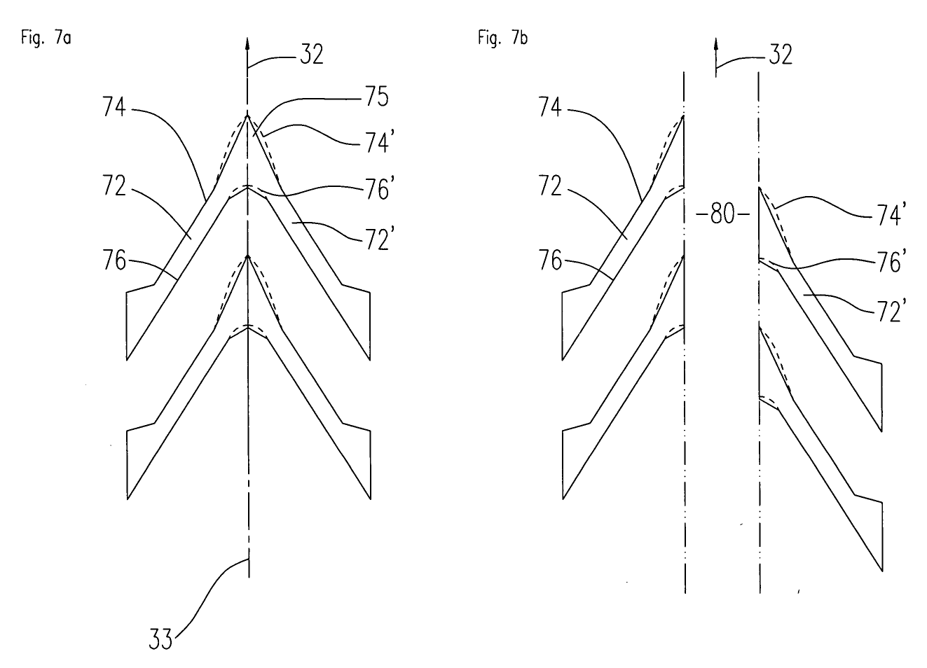

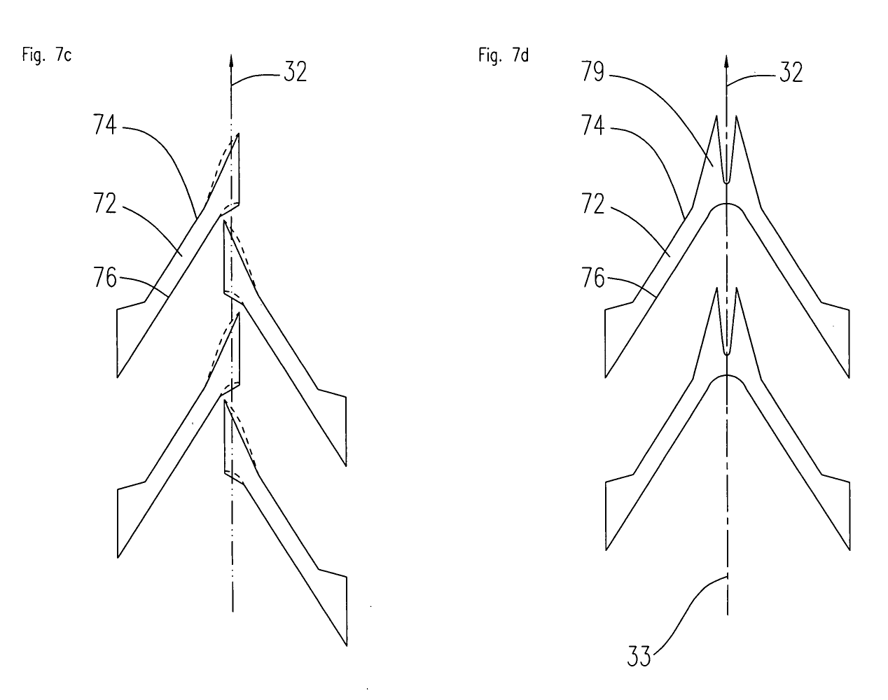

FIGS. 7a to 7c show a further embodiment of the grooved bearing patterns 72 or 72′ according to the invention. The grooved bearing pattern 72 has straight front edges and back edges, the front edge 74 being made up of a plurality of straight sections that run at varying angles with respect to the central axis 33. The modified design of the grooved bearing patterns 72′ comprises rounded or curved front edges 74′ or back edges 76′ respectively in the region of the sections that point in the direction of movement 32. The peak 75 ensures that the increased pressure that prevails in this region of the groove is distributed over a larger region and can therefore have a more uniform effect.

FIG. 7b shows the grooved bearing pattern of FIG. 7a whose sections are separated from one another by a land zone 80.

FIG. 7c shows the grooved bearing patterns 72 of FIG. 7a, which, as is also the case in FIG. 7b, are disposed at an offset along the central axis 33 and moreover overlap with respect to the central axis 33.

FIG. 7d shows a grooved bearing pattern 72 similar to that of FIG. 7a. The multiple peak 79 ensures a more highly optimized distribution of pressure.

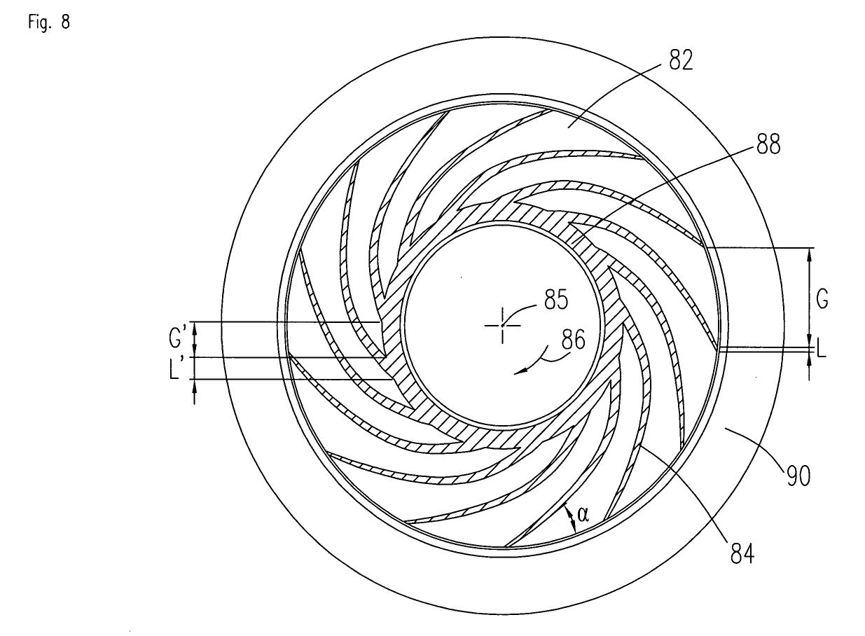

In FIG. 8, a view from above of a bearing surface 84 of an axial bearing is shown, the bearing surface 84 being annular in shape and rotating about an axis 85 in the direction of rotation 86. The bearing surface comprises a plurality of spiral-shaped grooved bearing patterns 82 that abut a rim zone 88 located at the inside diameter of the bearing surface 84. The grooved bearing patterns 82 have a defined depth. The rim zone 88 lies, for example, on the same level as the bearing surface 84. At the outside diameter of the bearing surface 84, the ends of the grooved bearing patterns 82 form, for example, a relatively acute angle α with the tangent of the bearing surface, this angle being larger than the angle formed by the ends of the grooved bearing patterns with the tangent of the rim zone 88. The ratio between the width G of the grooved bearing pattern 82 and the sum of G and the width L of the adjacent bearing surface 84 is referred to as the “Group Pitch Ratio” (GPR). The larger the width G for a defined number of grooved bearing patterns 82 within a defined bearing surface 84, the greater is the value GPR. In the example according to FIG. 8, the value GPR=G/(G+L) at the outside diameter of the bearing surface 84 is greater than the value GPR=G′/(G′+L′) at the inside diameter of the bearing surface 84. This value GPR variable over the bearing surface is also an important parameter that may vary according to the invention, particularly as a function of the width G of the grooved bearing pattern.

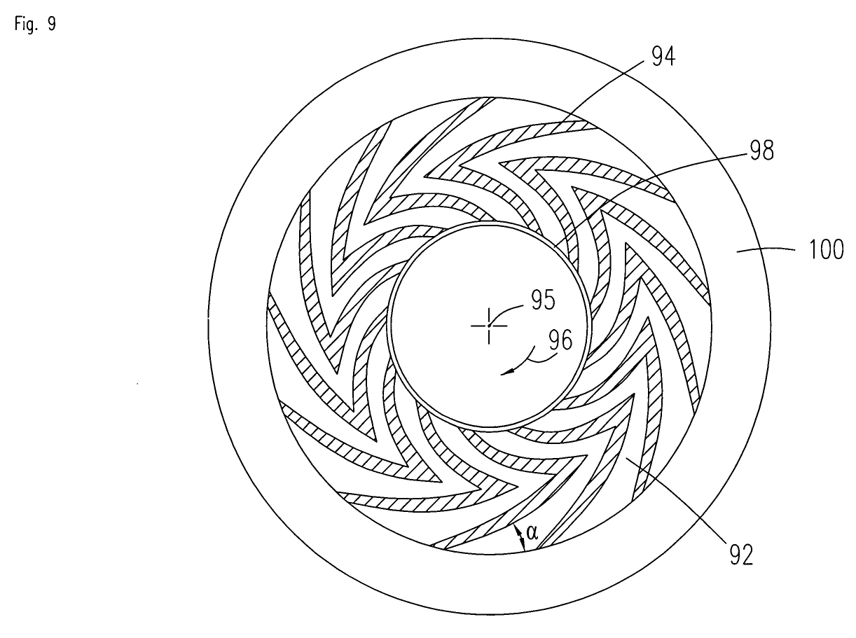

In FIG. 9, a view from above of a bearing surface 94 of an axial bearing is shown, the bearing surface 94 being provided with herringbone grooved bearing patterns 92. The bearing surface rotates, for example, about a rotational axis 95 in direction 96. Due to the variable width of the herringbone grooved bearing patterns 92, just as in FIG. 8, there is again a variable value GPR=G/(G+L). The bearing surface 94 is defined by an inner rim zone 98 and an outer rim zone 100, which, compared to the inner rim zone is relatively wide. The depth of the rim zone 98 and 100 is preferably the same size as the depth of the grooved bearing patterns 92, but may also be larger than the depth of the grooved bearing patterns 92. The angle α between the tangent of the outside circumference or inside circumference respectively of the bearing surface 94 is preferably a relatively acute angle.

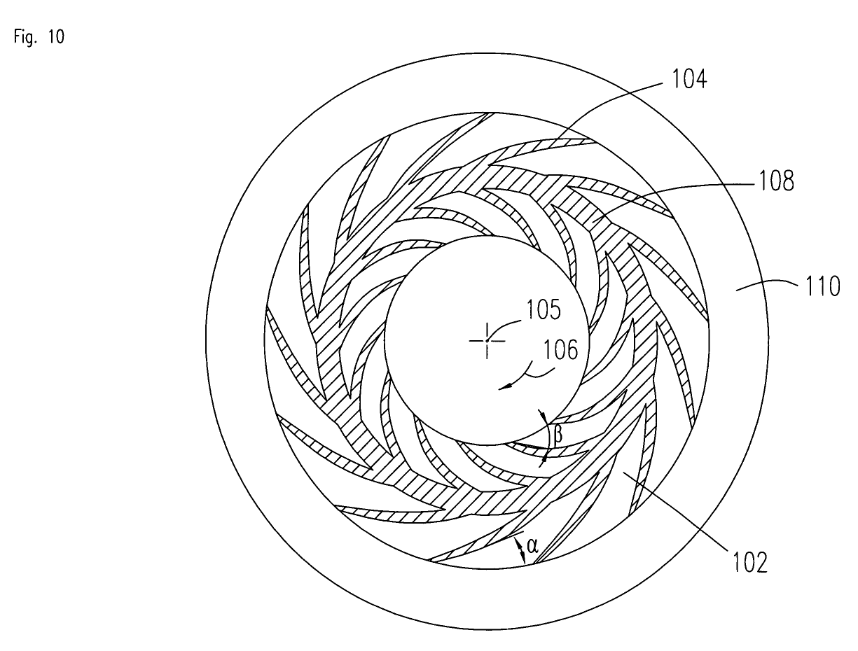

FIG. 10 shows a grooved bearing pattern 102 on a bearing surface 104 of an axial bearing for example, the grooved bearing pattern being given a substantially herringbone pattern and the sections of the herringbone bearing pattern 102 meeting each other at an angle being separated from one another by a central land zone 108. The land zone lies approximately on the same level as the bearing surface 104. The value GPR=G/(G+L) is again variable, which is given by the variable width of the grooved bearing patterns. The angles α or β that the grooved bearing pattern 102 encloses with the tangent of the inside diameter or outside diameter of the bearing surface 104, are acute angles, preferably less than 45°.

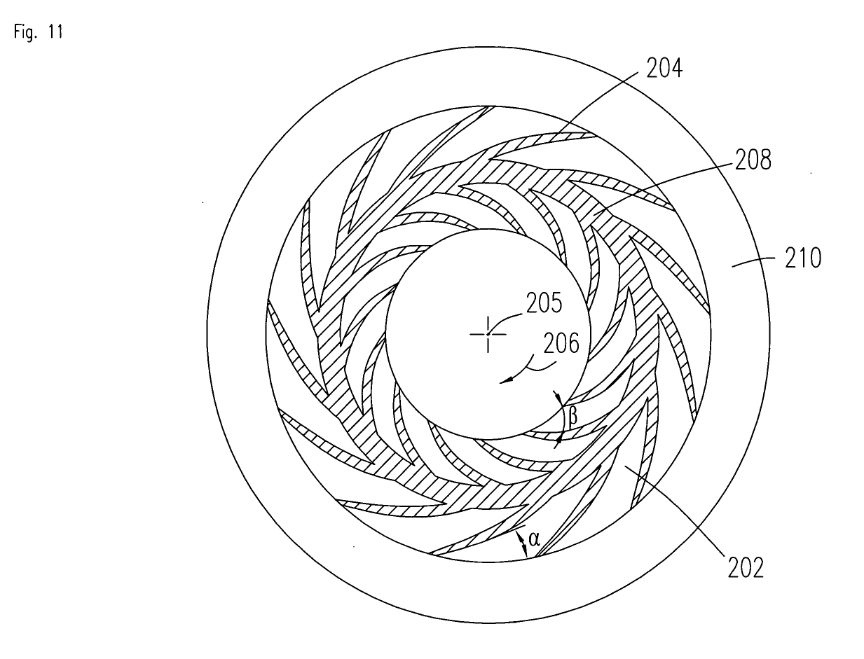

FIG. 11 shows a bearing surface 104 according to FIG. 10, the grooved bearing patterns 102 with respect to the arrangement of the land zone 108, however, being disposed at an offset with respect to one another. Otherwise the bearing patterns 102′ have the same characteristics as the bearing patterns 102 in FIG. 10.

Thus the main achievement of the invention is its avoidance of undesired negative pressure zones in the region of the grooved bearing patterns.

### IDENTIFICATION REFERENCE LIST

10 Bearing zone
12 Bearing groove
14 Bearing surface
15 Measuring line
16 Rim zone
17 Transition region
18 Depth profile
19 Chamfer
20 Depth profile
22 Depth profile
24 Depth profile
26 Depth profile
28 Depth profile
29 Groove cross-section
30 Depth profile
31 Groove cross-section
32 Direction of flow
33 Central axis
34 Bearing groove
36 Front edge
38 Back edge
39 Bearing surface
40 Land zone
42 Bearing groove
44 Front edge
46 Back edge
48 Bearing surface
50 Land zone
52 Bearing groove
54 Front edge
55 Distribution peak
56 Back edge
58 Bearing surface
60 Land zone
62 Bearing groove
64 Front edge
66 Back edge
68 Bearing surface
70 Land zone
72 Bearing groove
74 Front edge
75 Distribution peak
76 Back edge
78 Bearing surface
79 Distribution dual peak
80 Land zone
82 Bearing groove
84 Bearing surface
85 Rotational axis
86 Direction of rotation
88 Rim zone
90 Rim zone
92 Bearing groove
94 Bearing surface
95 Rotational axis
96 Direction of rotation
98 Rim zone
100 Rim zone
102 Bearing groove
102 Bearing surface
104 Rotational axis
105 Direction of rotation
108 Land zone
202 Bearing groove
204 Bearing surface
205 Rotational axis
206 Direction of rotation
208 Land zone

1. A method for optimizing a grooved bearing pattern on a bearing surface of a fluid dynamic bearing for the purpose of improving bearing properties, the grooved bearing pattern having a defined length, width and depth, and the bearing surface being moveable with respect to an associated opposing bearing surface in at least one direction of movement, the method comprising the following steps:
selection of a bearing property to be improved, and
optimization of the geometry of the grooved bearing pattern in respect of the bearing property to be improved by adjusting one or more of the following parameters of the grooved bearing pattern:
depth, width, length, angle with respect to the direction of movement of the bearing surface or its normal, contour, geometry of the transition to adjacent surfaces.

2. A method according to claim 1, characterized in that the bearing property is selected from the following properties: distribution of pressure in the bearing gap, bearing stiffness, bearing damping, bearing play, bearing friction.

3. A method according to claim 1, characterized in that the depth of the grooved bearing pattern is designed to vary over its length.

4. A method according to claim 1, characterized in that the width of the grooved bearing pattern is designed to vary over its length.

5. A method according to claim 1, characterized in that the grooved bearing pattern has an end pointing in and an end pointing away from the direction of movement, the depth of the grooved bearing pattern being designed such that in the direction of the end pointing away from the direction of movement it continuously or incrementally becomes smaller.

6. A method according to claim 1, characterized in that the grooved bearing pattern has an end pointing in and an end pointing away from the direction of movement, the width of the grooved bearing pattern being designed such that in the direction of the end pointing away from the direction of movement it continuously or incrementally becomes larger.

7. A method according to claim 1, characterized in that the grooved bearing pattern has an end pointing in and an end pointing away from the direction of movement, the angle of the grooved bearing pattern being designed such that in the direction of the end pointing away from the direction of movement it continuously or incrementally becomes smaller.

8. A method according to claim 1, characterized in that the grooved bearing pattern has an end pointing in and an end pointing away from the direction of movement, the width of the grooved bearing pattern both in the direction of the end pointing away from as well as the end pointing in the direction of movement being designed to be continuously or incrementally larger than in the remaining sections.

9. A method according to claim 1, characterized in that a plurality of grooved bearing patterns are disposed on the bearing surface in the same geometric alignment at a distance from one another, this distance varying over the length of the bearing patterns.

10. A method according to claim 1, characterized in that a plurality of grooved bearing patterns are disposed on the bearing surface and separated from one another by one or more land zones disposed on the bearing surface.

11. A method according to claim 1, characterized in that a plurality of grooved bearing patterns are disposed on the bearing surface such that they begin in a common channel and/or end in a common channel disposed on the bearing surface.

12. A method according to claim 1, characterized in that a plurality of grooved bearing patterns are disposed on the bearing surface such that they begin in a common land zone and/or end in a common land zone disposed on the bearing surface.

13. A grooved bearing pattern on a bearing surface of a fluid dynamic bearing, the grooved bearing pattern having a defined length, width and depth, and the bearing surface being moveable with respect to another associated bearing surface in at least one direction of movement, wherein the grooved bearing pattern in respect of an improvement in a bearing property is characterized by an adjustment of one or more of the following geometric parameters:
depth, width, length, angle with respect to direction of movement of the bearing surface or its normal, contour, geometry of the transition to adjacent surfaces.

14. A grooved bearing pattern according to claim 13, characterized in that the bearing property has one of the following properties:
distribution of pressure in a bearing gap separating the opposing bearing surfaces, bearing stiffness, bearing damping, bearing play, bearing friction.

15. A grooved bearing pattern according to claim 13, characterized in that the depth of the grooved bearing pattern varies over its length.

16. A grooved bearing pattern according to claim 13, characterized in that the width of the grooved bearing pattern varies over its length.

17. A grooved bearing pattern according to claim 13, characterized in that the grooved bearing pattern has an end pointing in and an end pointing away from the direction of movement, the depth of the grooved bearing pattern in the direction of the end pointing away from the direction of movement continuously or incrementally becoming smaller.

18. A grooved bearing pattern according to claims 13, characterized in that the grooved bearing pattern has an end pointing in and an end pointing away from the direction of movement, the width of the grooved bearing pattern in the direction of the end pointing away from the direction of movement continuously or incrementally becoming larger.

19. A grooved bearing pattern according to claims 13, characterized in that the grooved bearing pattern has an end pointing in and an end pointing away from the direction of movement, the angle of the grooved bearing pattern in the direction of the end pointing away from the direction of movement continuously or incrementally becoming smaller.

20. A grooved bearing pattern according to claim 13, characterized in that the grooved bearing pattern has an end pointing in and an end pointing away from the direction of movement, the width of the grooved bearing pattern both in the direction of the end pointing away from as well as the end pointing in the direction of movement being continuously or incrementally larger than in the remaining sections.

21. A grooved bearing pattern according to claim 13, characterized in that a plurality of bearing patterns are disposed on the bearing surface in the same geometric alignment at a distance from one another, this distance varying over the length of the bearing patterns.

22. A grooved bearing pattern according to claim 13, characterized in that a plurality of grooved bearing patterns are disposed on the bearing surface and separated from one another by one or more land zones disposed on the bearing surface.

23. A grooved bearing pattern according to claims 13, characterized in that a plurality of grooved bearing patterns are disposed on the bearing surface such that they begin in a common channel and/or end in a common channel disposed on the bearing surface.

24. A grooved bearing pattern according to claim 13, characterized in that it generates a pressure distribution peak or a multiple peak that are made up of two or more differently shaped peaks (55, 75, 79) directed in the direction of flow.
